(19) United States
(12) Patent Application Publication
(10) Pub. No.: US 2018/0180917 A1
(43) Pub. Date: Jun. 28, 2018

(54) FORCE TOUCH LIQUID CRYSTAL DISPLAY AND METHOD OF FABRICATING THE SAME

(71) Applicants: Shenzhen China Star Optoelectronics Technology Co., Ltd., Shenzhen, Guangdong (CN); Wuhan China Star Optoelectronics Technology Co., Ltd., Wuhan, Hubei (CN)

(72) Inventors: Man LI, Shenzhen, Guangdong (CN); Yao-Li HUANG, Shenzhen, Guangdong (CN); Xingling GUO, Shenzhen, Guangdong (CN)

(73) Assignees: Shenzhen China Star Optoelectronics Technology Co., Ltd., Shenzhen, Guangdong (CN); WUHAN CHINA STAR OPTOELECTRONICS TECHNOLOGY CO., LTD, Wuhan, Hubei, (CN)

(21) Appl. No.: 15/304,517

(22) PCT Filed: Aug. 3, 2016
(86) PCT No.: PCT/CN2016/093128

§ 371 Date: Oct. 15, 2016

(30) Foreign Application Priority Data
Jun. 6, 2016 (CN) 201610399243.6

(51) Int. Cl. G02F 1/1333; G02F 1/1335; G02F 1/1343

(52) U.S. Cl. CPC G02F 1/13338; G02F 1/133514; G02F 1/13439; G06F 3/0414; G02F 2201/121; G02F 2001/133302; G02F 2202/28

(57) ABSTRACT

A force touch liquid crystal display (LCD) includes: a touch panel configured to undertake a touch operation, a display module arranged on one side of the touch panel opposite to the touch panel, and a force film formed on a surface of the touch panel opposite to the display module. A method of fabricating the force touch LCD includes: forming a force film on one surface of a touch panel, and arranging the force film to face the display module, and attaching the touch panel to the display module. By using the force touch LCD, the problems that a force film is easily damaged because of backlight heat and force touch imbalance easily occurs are solved effectively and further the quality of force touch is well improved.

### BACKGROUND

### 1. Field of the Disclosure

The present disclosure relates to the field of a liquid crystal display (LCD), and more particularly, to a force touch LCD and a method of fabricating the force touch LCD.

### 2. Description of the Related Art

With the development of the intellectualization of an electronic device (such as a cellphone), the force touch technique, as a brand-new touch technique, is commonly applied in our daily life. The realization of the force touch technique is that an electronic device can sense a light press and a heavy press more easily and accordingly, different functions in response to the light press and the heavy press are demonstrated. A force film is a key component for the force touch. The force film is patterned with an indium tin oxide (ITO) pattern which is a specific touch force with a technique like silk screen printing. As FIG. 1 shows, a force touch thin film is formed by printing a sensor array 120 on a thin film substrate 110.

The force touch structure is mostly of a capacitance type; that is, a capacitor is formed on some metal layer (such a middle frame) between a force film and an LCD module. An insulating medium (such as air) characteristic of flexible deformation is needed in the middle of the capacitor. When a human's finger presses, the force film is deformed. Based on the formulas C=ϵ×A/d (ϵ indicates a permittivity of the insulating medium in the capacitor; A indicates the overlapping area of the upper and lower substrates; d is the distance of the upper and lower substrates), the variation of the distance d is accompanied by the variation of the capacitor C. The variation of the capacitor C is directly transformed into the variation of the electric signal through the electronic device, such as a cellphone. The variation of the electric signal is finally transmitted to a corresponding processor. The processor locates the specific position and sends a command to perform a corresponding function.

Currently, the force film 260 is usually arranged on a lower surface of a backlight module (BLM) 240 of a display module 250 and forms a pressure capacitor with a middle frame. FIG. 2 illustrates the structure of the LCD with such a force film. A touch screen 200 is attached to the display module 250 using an adhesive 220 such as optical clear adhesive (OCA). The display module 250 includes an LCD module 230 and the backlight module 240. The force film 260 is attached to the lower surface of the backlight module 240. The force film 260 is used as an upper electrode of the capacitor and forms a pressure capacitor with a lower middle frame 270 used as the lower electrode. Because a lot of grooves with asperity are on the middle frame 270, force touch imbalance easily occurs upon a condition that a force touch conducts. Besides, the force film 260 is near the backlight module 240 so the force film 260 is inclined to become hot and damaged.

### SUMMARY

A force touch liquid crystal display (LCD) and a method of fabricating the force touch LCD are proposed by the present disclosure. Since the force touch LCD has a good force touch structure, the LCD has a high-quality force touch.

According to a first aspect of the present disclosure, a force touch liquid crystal display (LCD) includes: a touch panel, configured to undertake a touch operation; a display module, arranged on one side of the touch panel opposite to the touch panel; and a force film, formed on a surface of the touch panel opposite to the display module.

According to a second aspect of the present disclosure, the touch panel is attached to the display module through an adhesive arranged on a periphery of the touch panel, and an air layer is formed between the touch panel and the display module.

According to a third aspect of the present disclosure, the display module comprises a color filter glass (CF glass), a liquid crystal layer, a common electrode, an array substrate, and a backlight module which are layered subsequently; a pressure capacitor is formed between the force film and the common electrode; the force film and the common electrode form two electrodes of the pressure capacitor.

According to a fourth aspect of the present disclosure, the force film is formed on the surface of the touch panel with a technique of silk screen printing.

According to a fifth aspect of the present disclosure, an indium tin oxide (ITO) pattern is formed on the force film on the surface of the touch panel with a technique of silk screen printing.

According to a sixth aspect of the present disclosure, the LCD is a twisted nematic (TN) LCD, a vertical alignment (VA) LCD, or an in-plane switching (IPS) LCD.

According to a seventh aspect of the present disclosure, a method of fabricating a force touch liquid crystal display (LCD) includes: forming a force film on one surface of a touch panel; and arranging the force film to face the display module, and attaching the touch panel to the display module.

According to a eighth aspect of the present disclosure, the display module comprises a color filter glass (CF glass), a liquid crystal layer, a common electrode, an array substrate, and a backlight module which are layered subsequently; a pressure capacitor is formed between the force film and the common electrode; the force film and the common electrode form two electrodes of the pressure capacitor.

According to a ninth aspect of the present disclosure, the touch panel is attached to the display module through an adhesive arranged on a periphery of the touch panel, and an air layer is formed between the touch panel and the display module.

According to a tenth aspect of the present disclosure, the force film is formed on the surface of the touch panel with a technique of silk screen printing.

Once the force touch LCD and the method of fabricating the force touch LCD are adopted, the problems that a force film is easily damaged because of backlight heat and force touch imbalance easily occurs are solved effectively and further the quality of force touch is well improved.

These and other features, aspects and advantages of the present disclosure will become understood with reference to the following description, appended claims and accompanying figures.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a schematic diagram of a conventional force film.

FIG. 2 shows a schematic diagram of a conventional force touch liquid crystal display.

FIG. 3 is a diagram illustrating a structural arrangement of a force touch liquid crystal display according to one preferred embodiment of the present disclosure.

FIG. 4 is a schematic diagram illustrating an attachment process of a touch panel and a display module.

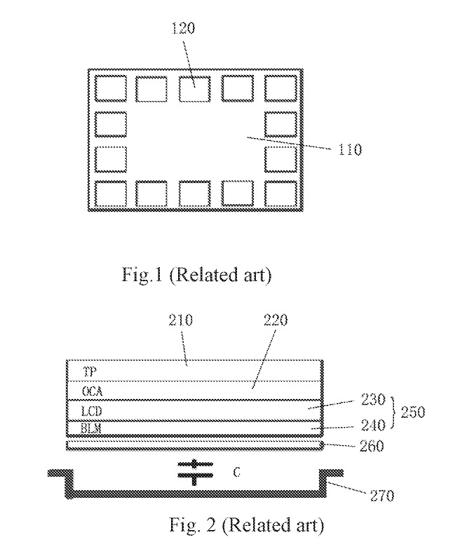

### DETAILED DESCRIPTION OF THE PREFERRED EMBODIMENTS

For better understanding embodiments of the present disclosure, the following detailed description taken in conjunction with the accompanying drawings is provided. Apparently, the accompanying drawings are merely for some of the embodiments of the present invention.

Any ordinarily skilled person in the technical field of the present invention could still obtain other accompanying drawings without use laborious invention based on the present accompanying drawings.

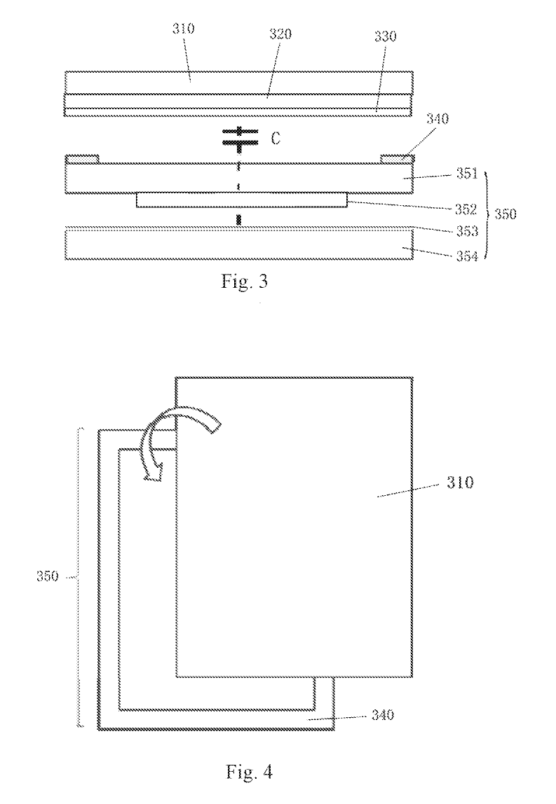

FIG. 3 is a diagram illustrating a structural arrangement of a force touch liquid crystal display (LCD) according to one preferred embodiment of the present disclosure. FIG. 4 is a schematic diagram illustrating an attachment process of a touch panel and a display module.

The force touch LCD includes a touch panel 320, a force film 330, and a display module 350. The touch panel 320 is used to receive a touch operation. The force film 330 is formed or arranged on a lower surface (back surface) of the touch panel 320. The display module 350 is arranged on a lower side of the touch panel 320 and is combined with the force film 330 through one kind of adhesive 340 such as optical clear adhesive (OCA) or a core reinforcement (COR) adhesive.

As mentioned above, the display module 350 may include a color filter glass (CF glass) 351, a liquid crystal layer (not shown), a common electrode 353, an array substrate (a thin-film transistor (TFT) array substrate 354), a backlight module (not shown), etc. The CF glass 351, the liquid crystal layer, the common electrode 353, the array substrate, and the backlight module are layered subsequently. A glass substrate 310 is further arranged on an outer side of the touch panel 320. The glass substrate 310 is used to protect the touch panel 320. A red/green/blue (RGB) unit is formed on the CF glass 351.

FIG. 4 illustrates the process of attaching the touch panel 320 to the display module 350 through a ring of adhesive 340 arranged on the periphery of the touch panel 320. In the process of attachment, a very thin air layer is usually spared between the touch panel 320 and the display module 350. The air layer can be used to form a capacitor required for the force touch. The force film 330 is fabricated on the lower surface of the touch panel 320 and may be used to be an upper electrode of the capacitor. A common electrode 353 inside the display module 350 may be a lower electrode of the capacitor. Finally, the force touch structure is formed.

In response to a touch of human's finger on the touch panel 320 with various amounts of force, the deformation of the force film 330 varies to various degrees. Different degrees of deformations result in different distances of a pressure capacitor and then variations of a press electric capacity. The variation of the capacitance is transformed into an electric signal and transmitted to a processor of a touch integrated circuit (IC). The processor finally sends a specific command to order the screen of the electronic device to perform a specific act according to the position and the signal of the positioning touch.

The adhesive used in the above-mentioned embodiments is not limited to the OCA and the COR adhesive. Other kinds of adhesives are adoptable as long as the adhesive is characteristic of strong adhesiveness and can satisfy the need to adhere the touch panel to the display module strongly without affecting the optical transmittance.

FIG. 4 illustrates the method of fabricating a force touch liquid crystal display (LCD) according to the preferred embodiment of the present disclosure. Firstly, form the force film on one surface of the edge-to-edge (OGS)-type touch panel with a process such as silk screen printing. Next, arrange the display module facing the force film. Next, coat an adhesive, such as the OCA, on the periphery of the touch panel to attach the touch panel to the display module so that the air layer is formed between the touch panel and the display module.

As the human finger touches the screen of the force touch LCD with different amounts of force, the deformation of the force film changes to different degrees. Different amounts of touch force also causes different distances between the upper and lower electrodes of the pressure capacitor and further variations of the press electric capacity of the pressure capacitor.

The variation of the capacitor will be transformed into the variation of the electric signal. The variation of the electric signal is transformed into the processor of the touch IC. The processor sends a specific command to order the force touch LCD (such as a cellphone) to finally perform a specific act according to the position and the signal of the positioning touch.

A liquid crystal display screen arranged in the force touch LCD may be a twisted nematic (TN) or vertical alignment (VA) liquid crystal display screen. In addition, the liquid crystal display screen may be a type of in-plane switching (IPS) or a fringe field switching (FFS).

In addition, the force touch structure in the force touch LCD proposed by the present disclosure can further be applied to an organic display device. That is, an organic display device can be a substitute for the LCD used in the present disclosure.

In the present disclosure, the force film is arranged on the lower surface of the touch panel and is separated from the backlight module so the force film cannot be damaged by the backlight heat. In addition, conventionally, a middle frame is used as a lower electrode of the capacitor. But, a force touch capacitor is formed between the touch panel and the display module so in the present disclosure no touch imbalance will occur, which enhances the quality of force touch successfully.

In addition, the structural arrangement of the force touch can be applied to a small- and medium-sized product adopting the touch technique to enhance the force touch quality well and improve the user's experience. The small- and medium-sized product includes a smartphone, a flat computer, a wearable smart watch, etc.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A force touch liquid crystal display (LCD), comprising:
a touch panel, configured to undertake a touch operation;
a display module, arranged on one side of the touch panel opposite to the touch panel;
and a force film, formed on a surface of the touch panel opposite to the display module.

2. The force touch LCD of claim 1, wherein the touch panel is attached to the display module through an adhesive arranged on a periphery of the touch panel, and an air layer is formed between the touch panel and the display module.

3. The force touch LCD of claim 2, wherein the display module comprises a color filter glass (CF glass), a liquid crystal layer, a common electrode, an array substrate, and a backlight module which are layered subsequently; a pressure capacitor is formed between the force film and the common electrode; the force film and the common electrode form two electrodes of the pressure capacitor.

4. The force touch LCD of claim 1, wherein the force film is formed on the surface of the touch panel with a technique of silk screen printing.

5. The force touch LCD of claim 1, wherein an indium tin oxide (ITO) pattern is formed on the force film on the surface of the touch panel with a technique of silk screen printing.

6. The force touch LCD of claim 1, wherein the LCD is a twisted nematic (TN) LCD, a vertical alignment (VA) LCD, or an in-plane switching (IPS) LCD.

7. The force touch LCD of claim 2, wherein the LCD is a twisted nematic (TN) LCD, a vertical alignment (VA) LCD, or an in-plane switching (IPS) LCD.

8. The force touch LCD of claim 3, wherein the LCD is a twisted nematic (TN) LCD, a vertical alignment (VA) LCD, or an in-plane switching (IPS) LCD.

9. The force touch LCD of claim 4, wherein the LCD is a twisted nematic (TN) LCD, a vertical alignment (VA) LCD, or an in-plane switching (IPS) LCD.

10. The force touch LCD of claim 5, wherein the LCD is a twisted nematic (TN) LCD, a vertical alignment (VA) LCD, or an in-plane switching (IPS) LCD.

11. A method of fabricating a force touch liquid crystal display (LCD), comprising steps of:
forming a force film on one surface of a touch panel;
arranging the force film to face the display module, and attaching the touch panel to the display module.

12. The method of claim 11, wherein the display module comprises a color filter glass (CF glass), a liquid crystal layer, a common electrode, an array substrate, and a backlight module which are layered subsequently; a pressure capacitor is formed between the force film and the common electrode; the force film and the common electrode form two electrodes of the pressure capacitor.

13. The method of claim 11, wherein the touch panel is attached to the display module through an adhesive arranged on a periphery of the touch panel, and an air layer is formed between the touch panel and the display module.

14. The method of claim 12, wherein the touch panel is attached to the display module through an adhesive arranged on a periphery of the touch panel, and an air layer is formed between the touch panel and the display module.

15. The method of claim 11, wherein the force film is formed on the surface of the touch panel with a technique of silk screen printing.

16. The method of claim 12, wherein the force film is formed on the surface of the touch panel with a technique of silk screen printing.
